(19) United States
(12) Patent Application Publication
(10) Pub. No.: US 2026/0330495 A1
(43) Pub. Date: Oct. 22, 2026

(54) REVERSE VENDING MACHINE AND METHOD IN A REVERSE VENDING MACHINE

(71) Applicant: GRIN AS, Oslo (NO)

(72) Inventors: Biplav KARNA, Oslo (NO); Jo KORNELIUSSEN, Oslo (NO); Sandeep SHIVAKOTI, Oslo (NO); Hallvard STEMSHAUG, Oslo (NO); Arnstein KLEVEN, Oslo (NO)

(73) Assignee: GRIN AS, Oslo (NO)

(21) Appl. No.: 19/114,111

(22) PCT Filed: Sep. 22, 2023
(86) PCT No.: PCT/NO2023/060053

§ 371 Date: Mar. 21, 2025

(30) Foreign Application Priority Data
Sep. 22, 2022 (NO) 20221006

(51) Int. Cl. G06Q 30/0207; G06V 10/147; G06V 10/764; G06V 10/82; G06V 20/52; G07F 7/06

(52) U.S. Cl. CPC G06Q 30/0237; G06V 10/147; G06V 10/764; G06V 20/52; G07F 7/06; G06V 10/82

(57) ABSTRACT

A reverse vending machine receiving items from an identified user. At least one image sensor observes the item in the machine, a tracking module tracks the item in order to determine whether it has been properly returned, and if so, at least one image from a sequence of images of the item is selected to be analyzed by an observation module to determine if the item is associated with a reward. A reward initiation module initiates provision of a reward to the identified user. A ramp is arranged such that when an item passes through the machine it will tilt when passing over the top or off the edge of the ramp allowing the image sensor to observe the item from different sides. The observation zone may also include mirrors to provide a view from more than one angle. Corresponding methods are also disclosed.

### TECHNICAL FIELD

The present invention relates to reverse vending machines, and in particular to reverse vending machines that are configured to receive and identify returned items for recycling, reuse, remanufacturing, repurposing, or trash.

### BACKGROUND

With the introduction of a circular economy, it is desirable to enable collection of used products, packaging, and other items that otherwise would be trashed and to utilize such items again or recycle the materials from which they are made. Many reverse vending machines exist for this purpose, but they are generally configured to receive only a narrow range of items such as glass or plastic bottles or aluminum cans. When such containers are sold, typically containing beverages, a monetary deposit is collected, and this deposit is refunded upon return of the container. Consequently, a fairly complex ecosystem has to be in place and reverse vending machines operating in this ecosystem are designed and configured to handle a limited range of pre-defined containers.

The circular economy requires greater flexibility and other incentive systems. Consequently, there is a need for reverse vending machines that can be configured to accept a wide range of items and that can be programmed to implement or support a wide range of incentive systems.

### SUMMARY OF THE DISCLOSURE

In order to address the shortcomings of current technology and facilitate a more efficient circular economy capable of circulating a wider range of products and materials, the present invention in a first aspect provides a reverse vending machine with a user interface configured to receive user input representing an identification of a user, an opening through which items can be inserted into the machine, and at least one image sensor configured to capture images of items as they are inserted into and moves through at least an observation zone in the machine. The reverse vending machine also includes a tracking and triggering module, and as items move through the observation zone, images from the image sensor are provided to the tracking and triggering module. The tracking and triggering module is configured to analyze image sequences in order to determine whether an item has been introduced into the reverse vending machine and has properly passed through the observation zone, and if it is determined that an item has properly passed through the observation zone, selecting at least one image from a sequence of images of that item in the observation zone. In order to analyze the at least one image selected by the tracking and triggering module an object recognition module is provided. The selected image or images are delivered as input to the object recognition module which is configured to determine if an object in an image selected by the tracking and triggering module can be recognized as a representation of an item associated with a reward. A reward initiation module is also provided and configured to, upon determination by the object recognition module that an item associated with a reward is represented in an image selected by the tracking and triggering module, performing at least one of storing or transmitting information that provides or can be used to provide the reward associated with the recognized item to a user identified by the user input.

The actual transfer of value to the user identified by the reverse vending machine is not necessarily performed by the machine as such, but a process of rewarding or compensating the user is initiated by the reward initiation module, possibly in order to be acted upon by systems external to the reverse vending machine, for example as a cloud-based service.

In some embodiments, a ramp is provided adjacent to the opening and comprising at least one of a flat surface with an edge and a curved surface such that when an item is introduced into the interior of the machine through the opening it will tilt when passing over the top or off the edge of the ramp, allowing the image sensor to observe the item from different sides.

In some embodiments of the invention the ramp is a flat surface comprising one of a) a single flat surface with an edge facing away from the opening, and b) two differently inclined planes, where the first plane is adjacent to the opening and sloping upwards and the second is following the first plane and sloping downwards, and the edge is defined by the meeting of the two planes.

Different embodiments of the invention may use different types of images sensors, and the selection of which type of image sensor to use is not dependent on the implementation that is selected for other features that may be implemented in different ways, except that different image sensors may require a light source of some type or another, while some image sensors may not. Some embodiments of the invention may use LIDAR technology in the image sensor. Other alternatives include camera or multispectral camera, in which case the reverse vending machine may further comprises a light source configured to emit soft light with a spectrum consistent with the spectral sensitivity of the camera. Other types of image sensors may also be contemplated, for example image sensors based on ultrasonic imaging.

In order to enable observation of returned items from several angles at the same time some embodiments of the invention may include at least one mirror provided in the observation zone. The at least one mirror may have a position and orientation which allows the at least one image sensor to simultaneously view an item in the observation zone directly from a first angle and in the at least one mirror from a second angle.

Some embodiments of the invention may include a door covering the opening and provided with a locking mechanism, and an authorization module. The authorization module may then be configured to deactivate the locking mechanism to provide access to the interior of the reverse vending machine only upon successful authorization of a user identified by user input received by the user interface.

Some embodiments of the invention may have a door provided at the end of the observation zone and provided with an opening mechanism. This may be instead of the door covering the opening or in addition to the door covering the opening. The object recognition module may then be configured to activate the opening mechanism only upon positive determination that an object in an image selected by the tracking and triggering module can be recognized as a representation of an item associated with a reward.

In some embodiments the tracking and triggering module is configured to use a computer vision algorithm to track an object in a sequence of images in order to determine whether an item has actually been returned and, for example, not simply been entered into the observation zone and then pulled back out again. The determination that an item has properly passed through the observation zone may be that tracking of the object in the sequence of images indicates that a) the item has entered the observation zone at the end closest to the opening, b) the item has subsequently left the observation zone from the end opposite to the opening, and c) the item has been tracked continuously through the observation zone.

The object recognition module may be configured to use a computer vision algorithm selected from the group consisting of: image processing, image analysis and neural networks.

The reward initiation module may be configured to perform at least one of a) transmitting to a cloud-based service, an identification of a user and an identification of a returned item, transmitting to a cloud-based service, an identification of a user and a representation of a reward value, and c) adding a reward value to a locally stored record associated with the identified user.

In some embodiments of the invention an inventory module is also provided. This module may be configured to maintain a record of items that have been determined by the tracking and triggering module to have been properly returned and have been recognized by the object recognition module as an item associated with a reward. That way the reverse vending machine may keep track of its contents and report this in a status report to a remote service.

In another aspect of the invention a method is provided for receiving an item in a reverse vending machine and providing a reward. This method includes receiving user input representing an identification of a user, providing access to the interior of the reverse vending machine, and using an image sensor to observe an item that is moved through an observation zone. A tracking and triggering module is used to analyze a sequence of images from the image sensor to determine whether an item has properly passed through the observation zone. If it is determined that an item has passed through the observation zone, at least one image is selected from the sequence of images. An object recognition module is used to determine if an object in the at least one selected image is a representation of an item associated with a reward, and if so, storing or transmitting information that provides or can be used to provide the reward associated with the recognized item to a user identified by the user input.

In some embodiments the observation zone includes a ramp with at least one of a flat surface with an edge and a curved surface such that when an item is introduced into the interior of the machine through the opening it will tilt while moving across the surface of the ramp allowing the image sensor to observe the item from different sides.

In some embodiments the ramp is a flat surface comprising one of a) a single flat surface with an edge facing away from the opening, and b) two differently inclined planes, where the first plane is adjacent to the opening and sloping upwards and the second is following the first plane and sloping downwards, and the edge is defined by the meeting of the two planes.

The observation zone, i.e., the part of the interior of the machine being observed by the at least one image sensor, may in some embodiments further include at least one mirror provided in the observation zone and the method may then further comprise simultaneously viewing an item in the observation zone directly from a first angle and in the at least one mirror from a second angle.

Some embodiments of the method may further include evaluating the information representing an identification of a user to determine if the identified user is authorized to use the reverse vending machine and only providing access to the interior of the reverse vending machine if it is determined that the user is authorized. The provision of access may, for example, be done by deactivating a locking mechanism or activating an actuator that opens a door.

The triggering module may be used to determine if an item has properly passed through the observation zone includes using a computer vision algorithm to track an object in a sequence of images and to determine that an item has properly passed through the observation zone only if tracking the object in the sequence of images indicates that a) the item has entered the observation zone at the end closest to the opening, b) the item has subsequently left the observation zone from the end opposite to the opening, and the item has been tracked continuously through the observation zone.

Various embodiments of the invention may, for the object recognition process performed by the object recognition module to determine if an object in the at least one selected image is a representation of an item associated with a reward includes using a computer vision algorithm selected from the group consisting of: image processing, image analysis and neural networks.

The method may in some embodiments include reward initiation in the form of at least one of a) transmitting to a cloud-based service, an identification of a user and an identification of a returned item, b) transmitting to a cloud-based service, an identification of a user and a representation of a reward value, and c) adding a reward value to a locally stored record associated with the identified user.

In some embodiments the method also include maintaining a record of items that have been determined through use of the tracking and triggering module to have been properly returned and have been recognized through use of the object recognition module as an item associated with a reward.

### BRIEF DESCRIPTION OF THE DRAWINGS

The invention will now be described in further detail by means of exemplary embodiments and with reference to the attached drawings, where:

FIG. 1 is an illustration of a circular economy;

FIG. 2 is a perspective view of the exterior of an embodiment of a reverse vending machine according to the invention;

FIG. 3A-D are views of different embodiments of an observation zone in the interior of a reverse vending machine and a number of associated components in an embodiment of the invention;

FIG. 4 shows three views of a reverse vending machine according to an embodiment of the invention, illustrating an item passing through the observation zone;

FIG. 5 is a top view and a perspective view of a ramp and mirror combination that may be part of the observation zone in embodiments of the invention;

FIG. 6 is a flow chart of a process of receiving, verifying and rewarding the return of an item in accordance with some embodiments of the invention;

FIG. 7 is an illustration of one situation where an item is properly returned and three situations where the item is not properly returned; and

FIG. 8 is an illustration of a number of modules that may be part of the information processing components of embodiments of the invention.

### DETAILED DESCRIPTION

The present invention represents a response to the need for a more flexible circular economy, particularly as it relates to return of products and packaging for recycling or reuse. In the following description of various embodiments, reference will be made to the drawings, in which like reference numerals denote the same or corresponding elements. The drawings are not necessarily to scale. Instead, certain features may be shown exaggerated in scale or in a somewhat simplified or schematic manner, wherein certain conventional elements may have been left out in the interest of exemplifying the principles of the invention rather than cluttering the drawings with details that do not contribute to the understanding of these principles.

It should be noted that, unless otherwise stated, different features or elements may be combined with each other whether or not they have been described together as part of the same embodiment below. The fact that several features are described with respect to a particular example should not be construed as implying that those features by necessity have to be included together in all embodiments of the invention. Conversely, features that are described with reference to different embodiments should not be construed as being mutually exclusive. The combination of features or elements in the drawings are intended to facilitate understanding of the invention rather than limit its scope to specific embodiments, and to the extent that alternative elements with substantially the same functionality are shown in respective embodiments, they are intended to be interchangeable across embodiments, not exclusively tied to the embodiment in which they are shown. For the sake of brevity, no attempt has been made to disclose a complete description of all possible permutations of features. As such, the different drawings do not represent distinct embodiments in the sense that they are exclusive alternatives to each other. Instead, the drawings may focus, for example, on different aspects or different levels of detail, or two drawings may show alternatives to more than one feature, and unless there is a dependency between the variations that a skilled person would immediately recognize (for example, an infrared light source may require an infrared camera), the intention is that alternatives may be freely combined from different drawings or parts of the description (for example, a particular closing mechanism and a particular type of camera).

This means that alternative embodiments to those shown in the drawings are arrived at by adding features, by removing features, or by configuring features in a different arrangement than that shown in the exemplary drawings. Unless features are explicitly identified as required or they functionally depend on each other to function they may be omitted, reconfigured, or made to interoperate with additional features not described herein, in any manner that is within the capabilities and knowledge of a skilled person having studied this disclosure. Similarly, if features are described with different levels of detail in sections referencing different drawings, this is not meant to imply that embodiments are constituted either by the lower level of detail or with the higher level of detail. Instead, details described with reference to one drawing are intended to be understood as being available but not mandatory in embodiments, such that none, some, or all features of a detailed example may be imported into a less detailed description unless otherwise stated or unless they clearly depend on each other for their intended operation.

Consequently, those with skill in the art will understand that the invention may be practiced without many of the details included in this detailed description. Conversely, some well-known structures or functions may not be shown or described in detail, in order to avoid unnecessarily obscuring the relevant description of the various implementations. The terminology used in the description presented below is intended to be interpreted in its broadest reasonable manner, even though it is being used in conjunction with a detailed description of certain specific implementations of the invention. To the extent that terms like first, second, upper, lower, left, right, near, far, and so on are used, they are intended to primarily distinguish features from each other, and not to define an absolute relationship, except where the context dictates otherwise (for example, if something is described as falling from an upper to a lower area). In particular the term item is intended to refer to an actual physical object that is being returned using a reverse vending machine, while the term object is intended to refer to the representation of this item or anything else in an image frame. Thus, generally speaking, an object is a representation of an item in an image. There is a chance that this practice is not adhered to everywhere in the present disclosure, but context should clarify the actual meaning of these words in each case.

Current use of resources is to a large extent linear in the sense that materials are extracted, refined, products are made, and eventually they are disposed of as waste. A circular economy is based on principles of elimination of waste and pollution, reuse of resources by circulation of products and materials at their highest value, and regeneration of nature. This requires an ecosystem where resources are captured before they are thrown away as trash, and preferably in a manner where as much as possible of the intrinsic value of the resources can be reused at the lowest possible expense of new resources. Consequently, the highest possible value is retained if products can be shared with other users after they are no longer needed by the current user. If the product is only slightly degraded it can be maintained or repaired and reused. For products that are beyond repair, components may be reused and redistributed, and finally, if no parts are salvageable as such, the materials may be recycled in the manufacture of new products.

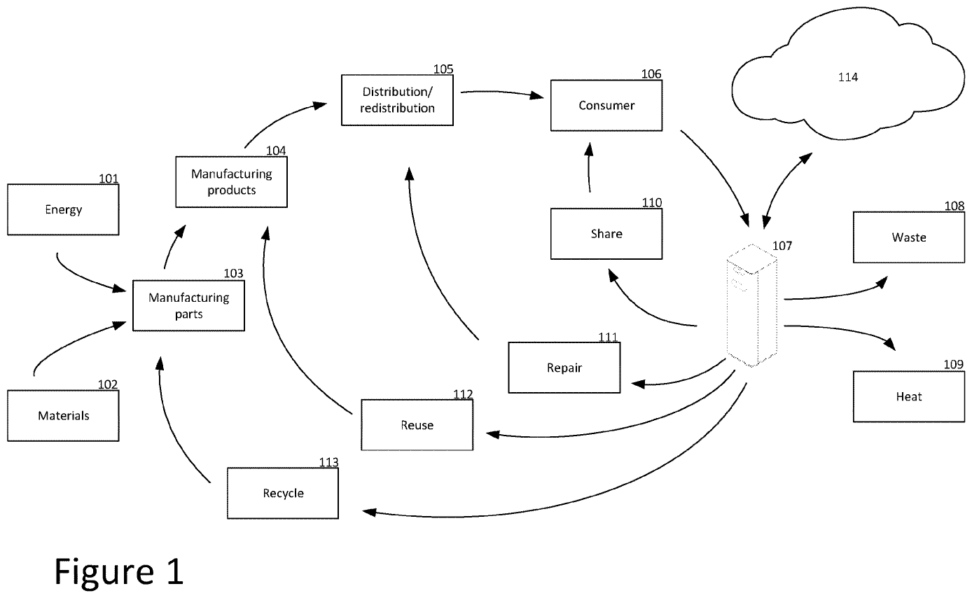

Reference is first made to FIG. 1 which schematically illustrates a circular economy, the facilitation of which the present invention is intended to contribute. The illustration is conceptual and does, of course, not illustrate all aspects of an economy.

Input into this economy, as is also the case with a traditional linear economy, includes energy 101 and materials 102. One aspect of a circular economy is the attempt to reduce this input as much as possible. Energy 101 and raw materials 102 is in particular introduced into the manufacturing of parts 103. Parts 103 are in turn used to manufacture products 104. Products 104 are then distributed 105 until they reach consumers 106. After a consumer no longer has any use for a product it may be collected at a collection point 107. In a traditional linear economy, the collection point 107 may simply be a trash can from where trash is collected and disposed of as waste 108. Some trash may be sent to an incineration plant 109, or waste-to-energy plant, where the trash is burnt to produce heat which in turn can be used to produce electricity or can be distributed through pipes in order to heat buildings. This will, of course, produce a certain amount of pollution and remove the materials from future recycling, but may be better than disposing of it in a landfill.

However, some products may still be perfectly usable even if they no longer have any utility for the original consumer 106. If this is the case the product may be shared 110 with other consumers 106. If the product may be repaired 111 it may be redistributed 105, or perhaps parts of the product may be reused 112 to manufacture 104 new products. If no parts are salvageable the materials from which the product was made may be recycled 113 and the materials may be used to manufacture new parts 103. For the purposes of this disclosure, repair 111 may include everything from cleaning (e.g., beverage containers), routine maintenance, to more substantial repairs, restorations, and rebuilding.

It will be understood that the most efficient implementation of this circular economy is one that is able to return a product that has been disposed of at the highest possible level. In other words, it is—as a rule—better to continue using than to have to repair, it is better to repair than to salvage parts, and it is better to salvage parts than to recycle materials. However, in order to enable this it is necessary to ensure that the collection point 107 enables the most efficient handling of disposed of products. This includes efficient collection of disposed of products at collection points 107 and efficient collection, processing, and utilization of information about the items that have been collected. The latter requires collection points that are connected with and capable of providing information to cloud based services 114.

The present invention provides an improved collection point in such a circular economy in the form of a reverse vending machine which may be configured in a much more flexible manner than reverse vending machines that are known in the art and enables incentives for consumers and efficient information handling for operators while providing new efficiency, security, and flexibility.

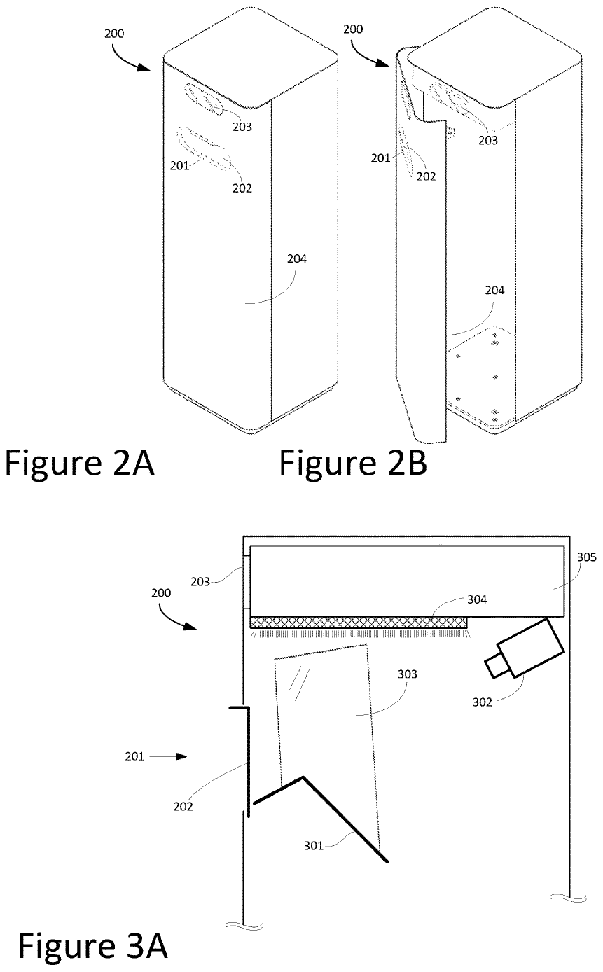

FIG. 2 shows a reverse vending machine 200 in accordance with the invention. FIG. 2 includes two views, where FIG. 2A shows the reverse vending machine 200 closed, and FIG. 2B shows the same reverse vending machine 200 with an open service door 204.

The reverse vending machine 200 includes an opening 201 through which items can be inserted into the machine 200. The opening 201 is provided with a door 202 which may be closed to prevent unauthorized access to the interior of the machine 200 or to otherwise protect internal components from the environment. Although some embodiments of the invention may be configured to allow unauthorized access, requiring authorization before unlocking the door 202 may prevent or limit return of unwanted items. For example, if a reverse vending machine 200 according to the invention is used to collect reusable cups, a person authorized to use the machine is more likely to know that paper cups that cannot be reused are not acceptable items.

The reverse vending machine 200 also includes a user interface 203. This user interface can be used to receive input from a user who wants to obtain access to the reverse vending machine 200 as well as to provide output in the form of confirmation that access is granted, status of the reverse vending machine, and information about a reward or compensation obtained as a result of the depositing of one or more qualifying items into the machine 200. The user interface may include a display, a touchscreen, a keyboard, a camera, a loudspeaker, an NFC reader, an RFID reader, indicator lamps, buttons and switches in any combination considered convenient by a designer for a particular use case.

The front of the machine 200 may be a service door 204 which provides access to service personnel in order to remove returned items or perform maintenance and repair on the machine.

The two views of FIG. 2 are intended to illustrate the external configuration of one possible embodiment of a reverse vending machine 200 according to the invention. It should be noted that while the view of the machine 200 with open service door 204 does not show any internal components this is not intended to imply that this or any other embodiment of the invention may not include any internal components in addition to those illustrated in this drawing.

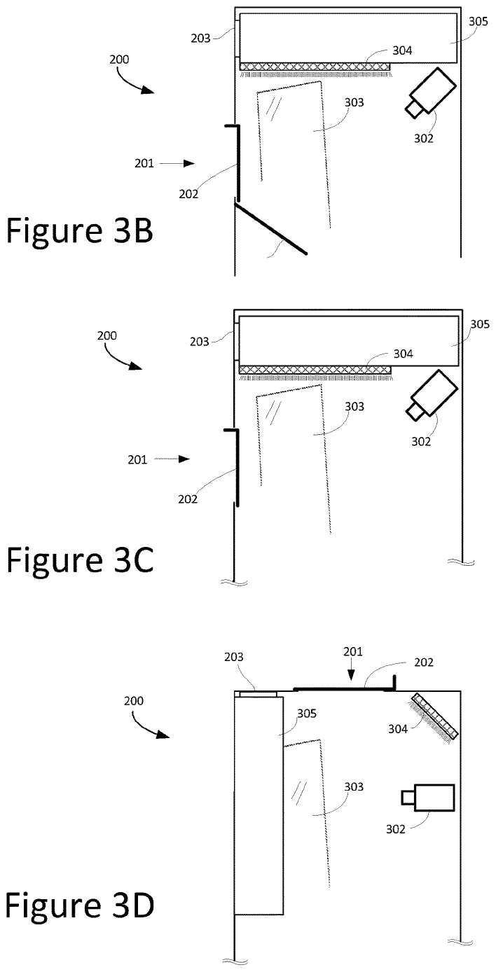

Turning now to FIG. 3A a description of some of the internal components of the reverse vending machine 200 will be provided. Reference numbers from previous drawings will be reused if they refer to the same or corresponding components, and this will be the case throughout this disclosure.

FIG. 3A shows an internal view of the upper part of the reverse vending machine 200. In this embodiment the door 202 is configured to be pushed downwards by a user in order to provide access through the opening 201 in order to deposit one or more items. The reverse vending machine may be provided with a locking mechanism (not shown) which prevents unauthorized access to the machine 200 but which disengages upon successful authorization of a user.

Just inside and adjacent to the opening 201 is a ramp or slide 301. In this example the ramp comprises two differently inclined planes, the one adjacent to the opening 201 is sloping upwards and it is followed by one sloping downwards such that when an item is introduced into the interior of the machine through the opening, it will tilt when it moves across the top where the two planes meet, thereby changing orientation while moving across the surface of the ramp 301. Instead of two planes the ramp may be configured, for example, as a curved surface as long as the shape of the ramp 301 causes an item to tilt when moving across the ramp 301. A simpler solution is to use ramp comprising only a single flat surface such that the item tilts when moving off the end of the surface. The latter alternative is shown in FIG. 3B where the ramp is inclined in order to allow returned objects to slide into the reverse vending machine 200. In all cases the ramp may also be configured to provide a uniform background against which the returned objects are observed by the image sensor. Which shape to choose in any particular embodiment depends primarily on convenience and ease of production. The shape illustrated in the drawing is therefore not dependent on any other features shown in this drawing if such features are optional or may be replaced with alternatives described elsewhere in this disclosure. However, the examples shown and described herein only show the two-surface version of the ramp 301, but in every single instance another shape that would allow the item to tilt while moving could be substituted.

While an item is moving across the surface of the ramp 301, and possibly also when it is dropping off the ramp and falling towards a container in the lower part of the reverse vending machine 200, it is observed by at least one image sensor 302. The image sensor 302 is positioned and oriented such as to be able to view an item while it is being moved into the reverse vending machine and as it tilts while passing over the top of the ramp 301, or in the case of a single surface ramp, when it moves off the end of the ramp 301. In this way the image sensor is able to observe the item from more than one side. This may be further facilitated by one or more mirrors 303 which are positioned such that the image sensor 302 obtains a view of the item from a different angle in the mirror or mirrors 303. It is, however, consistent with the principles of the invention to use multiple image sensors 302 instead of mirrors 303, or multiple image sensors 302 may be combined with one or more mirrors 303. How to choose the number and configuration of image sensors 302 and mirrors 303 is not dependent on other features illustrated in this drawing. Instead, a designer of a particular embodiment may want to consider the size and shape of the items the reverse vending machine is expected to receive, the extent to which these items are easily distinguished from each other and from unknown items, whether the items can be expected to bear markings such as bar codes or matrix codes and so on. Configuration may also depend on measures implemented for fraud prevention, which will be described in further detail below.

The image sensor or sensors 302 may be high speed video operating, for example, at 60 frames per second or even as fast as 120 frames per second. Furthermore, the image sensors may be sensitive to visible light, but some embodiments may use multispectral cameras or infrared (IR). The invention may also be implemented using other types of image sensors, for example LIDAR or ultrasonic imaging. In order to obtain clear images, the reverse vending machine 200 may be provided with one or more light sources 304. The light sources 304 should provide soft light in order to ensure that an item is evenly illuminated without unwanted shadows that make it difficult to observe shapes and other features or that may be incorrectly interpreted as a feature of shape of the item that is being observed. The spectrum of the light source should be consistent with the spectral sensitivity of the image sensor(s) 302. Some image sensors, for example LIDAR, inherently include their own light source and may not require an additional light source 304, while ultrasonic imaging would not depend on a light source at all.

The operation of the reverse vending machine 200 may be controlled by a controller 305 which may be a computing device in the form of a general-purpose computer with a CPU, memory, communication interface enabling communication with the cloud 114, and interfaces towards the image sensor 302, the user interface 203, the light source 304, and the locking mechanism for the door 202. The memory of the controller 305 may include instructions that enable the controller 305 to perform functions such as obtaining identification from a user, authorizing access, controlling the locking mechanism for the door 202, and if present, controlling an actuator which opens and closes the door 202, and the light source, and activating and receiving images from the image sensor 302, and processing received images as will be described in further detail below. It will be understood that, for example, the light source 304 and the image sensor 302 may be activated by a switch connected to the door 202 or by some other means, or the image sensor 302 may be permanently active for example in order to be able to detect attempts at breaking into the reverse vending machine 200.

FIG. 3C is a view corresponding to the views shown in FIGS. 3A and 3B. However, in this embodiment the ramp 301 is not included. In the exemplary embodiment in FIG. 3D the opening 201 has also been given a different position, namely on the top of the reverse vending machine 200. The door 201 is now more like a lid which must be opened such that returned objects can be dropped into the reverse vending machine 200. It should be understood that positioning the opening 201 on the top of the reverse vending machine 200 is not a necessary feature for all embodiments without a ramp 301, as FIG. 3B illustrates, and conversely, positioning the opening 201 on the top of the reverse vending machine 200 may also be a feature of embodiments that include a ramp 301. In this example, the housing of the controller 305 may provide a uniform background against which returned objects are viewed by the image sensor 302. It should, however, be noted that the extent to which the background needs to be uniform, in what way it needs to be uniform (e.g., in terms of color), and whether the background is provided by a ramp 301, or any other part of the interior of the reverse vending machine 200 may be design and configuration parameters that can be left to the designer of specific implementations.

It will be realized that in embodiments without the ramp 301, the returned object 401 will not tilt in the way described above. As mentioned above, tilting enables the image sensor to observe the item from more than one side. The extent to which the tilting significantly improves tracking and identification of returned objects (which will be described further below) may depend on other features of the reverse vending machine 200 including light, background, mirrors, as well as the algorithms processing the data received from the image sensor. It may also depend on aspects of the returned objects the reverse vending machine 200 is configured to receive and recognize. The following description of embodiments includes ramps in the described embodiments in order to give a complete description, but it will be understood that other features of the invention do not depend on the inclusion of a ramp 301, and that for example dropping a returned object that will fall freely through the observation zone can be substituted for the ramp in the following examples.

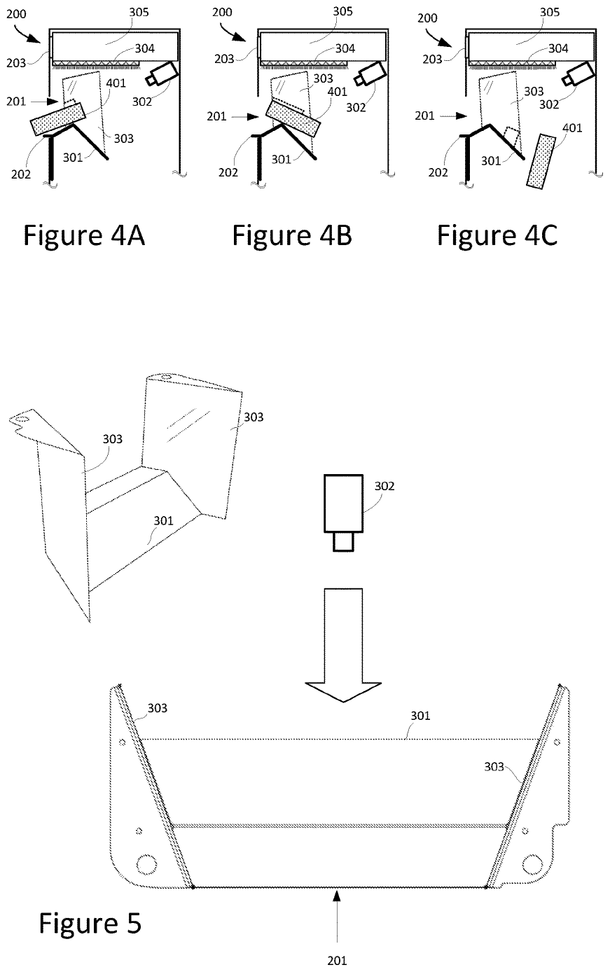

FIG. 4 shows an example where an item 401 is introduced into the interior of the reverse vending machine 200. It can be assumed that a user has been identified based on input from the user interface and that the controller 305 has disengaged the locking mechanism such that the user has been able to open the door 202. The user has then moved an item 401 in through the opening 201. The controller has also activated the light source 304 and started receiving images from the image sensor 302. The image sensor 302 registers images of the item 401 as it moves up the ramp 301 in FIG. 4A, down the ramp in FIG. 4B, and falls off the ramp 301 and downwards into the lower parts of the machine 201 in FIG. 4C. The image sensor also observes the mirror(s) 303 where a dashed line represents the mirror image of the item 401. From these illustrations it will be understood that the item 401 will be registered from several sides by the image sensor 302 as it tilts over the ramp 301, falls off the ramp, and is reflected in the mirrors 303.

FIG. 5 is a top view of the interior of an embodiment of the invention. This view only shows the ramp 301 and two mirrors 303, as well as a representation of the image sensor 302. A returned item will be moved through the opening 201 in the direction of the arrow and move towards the top of the ramp before sliding down on the other side. The image sensor 302 will observe the item and the mirrors as indicated by the 2D arrow above the drawing, and the image sensor will therefore view the item directly from straight on as well as indirectly from two sides (through the mirrors). In this embodiment the planes of the two mirrors 303 are at an angle of 40° to each other and 110° to the plane of the opening 201 (the front of the reverse vending machine 200), but different orientation of the mirror or mirrors may be contemplated based on the dimensions and relative position of the various components of the system and the size and shape of returned items. The position of the image sensor is, of course, particularly relevant and the position indicated in this drawing is only intended to illustrate the side from which the image sensor is viewing the mirrors in this configuration. The drawing is not intended to be in scale. The drawing also includes a perspective view of the same component with the ramp 301 and the mirrors 303.

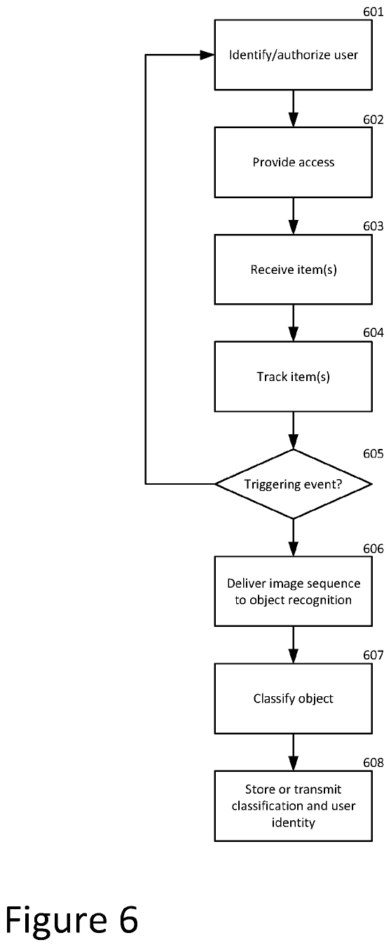

Reference is now made to FIG. 6 which is a flowchart giving an overview of a process where an item is returned to the reverse vending machine 200 by a user. The process is initiated by a user when the user presents some kind of identification or credential to the reverse vending machine using the user interface 203. The invention is capable of implementing many different methods for user identification and authorization and the invention is not limited to any specific such method. Examples include presenting a smart card, using a mobile phone with NFC, a dedicated app installed on a mobile phone and capable of requesting authorization by communicating with the cloud 114, sending a text message (SMS) to a number associated with the reverse vending machine 200, entering credentials using the user interface (e.g., username and password, facial recognition, fingerprint recognition), and so on. However, the invention is not limited to personal identification of the user. Other possibilities include user identification and authorization associated with the returned items themselves. For example, many products are sold with a unique identity. If a product is associated with a specific user when it is sold that user may be considered identified and authorized if the reverse vending machine can identify the unique product for example by reading an NFC or RFID tag attached to the item. A product may also be associated not with an individual user but for example with the producer or distributor. If this is the case the item may be scanned by the user interface or viewed by an external camera that is part of the user interface and upon recognition based on, e.g., an NFC or RFID tag, a QR or barcode, or object recognition, the producer or distributor of that product may be the user that is actually identified and that will be rewarded.

After use of the reverse vending machine 200 has been authorized in step 601, access is provided in step 602. This may be done by deactivation of a locking mechanism, or by activation of a motor or actuator configured to open a door 202 which otherwise covers an opening 201 into the reverse vending machine 200. It should, however, be noted that some embodiments of the invention may allow access to the reverse vending machine 200 with or without authorization, in which case no reward will be provided in cases where the user has not been identified. Some embodiments may provide rewards in the form of coupons if the user is not identified.

After access has been provided in step 602 the door 202 is or may be opened, providing access to the interior of the reverse vending machine 200. The user may now put any item he or she intends to return in through the opening 201. When the item is received in step 603 it is moved into an observation zone which is the part of the interior of the reverse vending machine 200 that is observed by one or more image sensors 302 directly or through one or more mirrors 303. The item will be moved over the top of the ramp 301, tilt forward and fall off the ramp. During this movement the item will be tracked by the image sensor or sensors 302. This tracking is substantially continuous, for example in the form of 60 frames per second, or even 120 frames per second video. The invention is, however, not limited to any specific frame rate. Instead, the frame rate may be adapted based what is determined to be required in a given context, for example in view of overall dimensions, typical speed of movement of items through the observation zone, etc.

While the item is tracked in step 604, the generated image sequence is processed in order to determine whether the passing of the item through the observation zone can be considered a triggering event. A triggering event is detected if it is determined that one or more items have properly passed through the observation zone and that these items (in embodiments that implement additional criteria) cannot be excluded as not qualifying is tracked through the observation zone. Some additional exclusions will be discussed below.

If it is determined in step 605 that there has been no triggering event, and if, for example, the process has timed out, the locking mechanism will be reactivated and the process will return to step 601 to wait for new authorization. If, however, a triggering event has been detected the process moves to step 606 where one image or a sequence of images captured by the image sensor while the item was passing through the observation zone is forwarded to object recognition. It should be noted that while all the images captured during the item's passing through the observation zone, or all the images associated with the detected triggering event, may be forwarded, it is also consistent with the principles of the invention to pre-process the images in order to forward only those most likely to be useful for object recognition, or some other rule may be implemented for example by removing images from the beginning and the end of the sequence or selecting a subset of images and removing the rest (for example by removing every other image or removing more images from the beginning of the sequence while the item is moving slowly and keeping all images from the end of the sequence while the item is falling). In some embodiments only one image is forwarded to object recognition and classification.

In embodiments where only one image is forwarded to object recognition and classification, an image that captures as much as possible of the item may be selected for this purpose. By having a sequence of images available, including images obtained from different angles of observation and images including views obtained with mirrors, the object recognition process has much more information to work with. If the object recognition process is able to identify a qualifying object in the frame or sequence of frames, the object is classified in step 607. Classification may impose different requirements. Some embodiments of the invention may successfully detect and classify based on recognition of a qualifying object in a single frame. Other embodiments may require recognition in at least a predetermined number of frames. The method may also implement different levels of confidence and require, for example, that a combined confidence for several frames must be above a predetermined level. In embodiments or cases where the returned item has already been recognized by RFID or reading of a QR code the tracking and triggering process may still be performed in order to ensure that the item is actually returned correctly, and the object recognition and classification is performed in order to verify that the object is complete (or sufficiently complete) so that users are not rewarded for simply returning an RFID tag or a small part carrying the a QR code of a larger item.

Initiation of the reward process in step 608 will at least include determination that the returned item is at least potentially associated with a reward and storing or transmitting information to that effect together with the identity of the user identified in the authorization process. The additional steps involved in the rewarding process may be implemented in a number of different ways that are all in accordance with the invention. The reward process as a whole involves identification and classification of the returned item, determination of the reward associated with that item or class of items, and the transfer of that reward to the user identified in the authorization process. These steps may, however, be distributed and do not all have to be performed by the controller 305 or in the reverse vending machine 200 at all. In some embodiments sufficient information is available to the controller 305 for the controller to determine, either by looking up in a table or database stored in local memory or by requesting this information from the cloud 114, the reward value that should be credited to the user. In other embodiments the controller 305 simply transmits the results of the recognition and classification step 607 to the cloud. The information may then be processed in the cloud 114 in order to determine the reward value and provide this to the user, for example by transferring value to an account, increasing a credit value or reward value in a database or a list, or something similar. In some embodiments the controller 305 may be configured to perform all steps associated with the reward, including adding the determined value to an account that is stored locally or by transmitting a determined reward value and the user identity to the cloud where it will be stored. It should be noted that the invention may also be used in contexts where there is a penalty for not returning an item, and where the reward is the avoidance of that penalty. The reward may also represent a possibility of a further reward, for example in the form of a ticket or stake in a lottery. The invention as such does not concern itself with the actual nature of the reward.

It should be noted that embodiments of the invention may be configured to detect more than one item per image frame. This means that the tracking of items and detection of a triggering event in steps 604 and 605 as well as the object recognition and classification in step 607 may be able to process images with several items. Similarly, several triggering events may be detected based on one initiating authorization. This means that while the door 202 is open a user may enter a number of items into the reverse vending machine. Some of these items may be entered at the same time, and some of them may be entered one after another in a manner that results in image frames containing the end of one triggering event and the beginning of another. In other words, if a triggering event is defined as the sequence of images capturing a particular item while it passes through the observation zone, some triggering events may overlap such that certain image frames can be associated with more than one triggering event. A triggering event determines that image frames within a certain time interval should be sent to object recognition. It may not be necessary to send image frames from overlapping triggering events several times, however, in some embodiments of the invention this may be done as a design choice.

As mentioned above, a triggering event is detected if an item that cannot be excluded is moved through the observation zone. An item may be excluded if it does not fulfill certain requirements or parameters, which may be determined by settings. For example, items may have to be within a certain size range, certain colors may be excluded (or only certain colors may be acceptable), and certain shapes may similarly be excluded or required. The detection of a triggering event is designed to determine that a particular sequence of image frames should be further processed for object recognition and classification. Consequently, the triggering algorithm does not have to distinguish between qualifying and non-qualifying items-if a non-qualifying item is sent to object recognition and classification, it will be determined in that subsequent process whether the item is validated as a return of a qualifying item and should result in a reward. In other words, a triggering event is a process of detecting that an item passes properly through the observation zone (i.e., is actually returned) and of selecting the image frames related to this event that should be sent to object recognition and classification.

Thus, sending images of a non-qualifying item to object recognition based on a correctly detected triggering event will not result in any identification of a qualifying item in step 607, which in turn means that no rewarding process will be initiated in step 608. The opposite situation, that of sending images of a qualifying item to object recognition based on an incorrectly detected triggering event, is, however, a potential problem that needs to be avoided. What this means is that if a triggering event is detected in a situation where a qualifying item is not actually returned, only entered into the observation zone and subsequently withdrawn images of the qualifying object be sent to object detection and classification despite the fact that it was not actually returned, and the user would be rewarded when he or she should not be. Consequently, it is important that a triggering event is only detected when an item (whether it is qualifying or not) is actually properly returned.

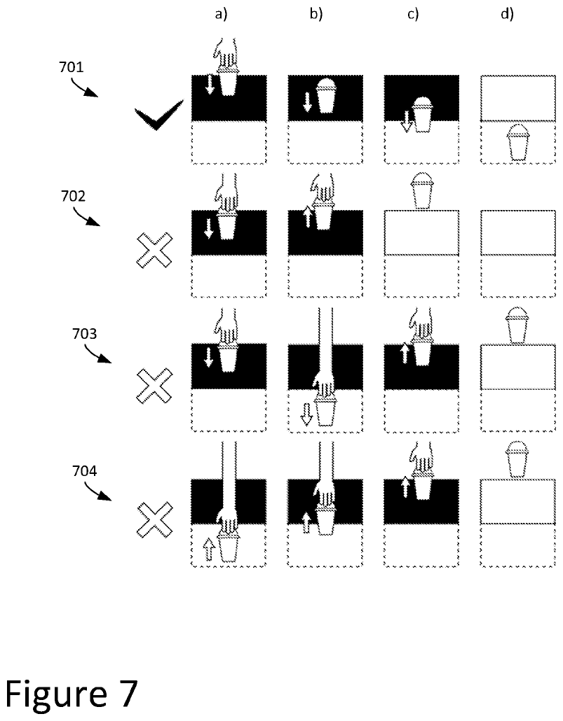

FIG. 7 illustrates one triggering event 701 and three events 702, 703, 704 that should not trigger further processing. In order not to clutter this drawing, reference numbers are not included except for the references to the respective events. In the first event 701 an item is moved into the reverse vending machine and enters the observation zone 701a). The user lets go and removes his hand when the entire item is in the observation zone 7101 b). Next 701c), the item is on its way out of the observation zone on the other side, and finally 701d) the item is again outside the observation zone and resting in a container or bin in the lower part of the reverse vending machine 200. This is how an event is expected to progress and the result should be a triggering of further processing with a sequence of image frames delivered to the object recognition and classification process.

The event 702 illustrated the second row should not result in triggering of further processing. In this case an item is initially correctly moved into the observation zone as in the previous case. However, the user does not let go. Instead, the user pulls the item out of the reverse vending machine 200 again 702b) and the item ends up on the outside of the machine 702c) and 702d). The tracking process will in this case observe an object that enters and leaves the observation zone from the same side, and it should therefore be determined that this is not a triggering event.

The next example, the event 703 in the third row, again starts with an item being moved into the observation zone 703a). In this case the item does indeed leave the observation zone at the other side 703b) but in this case the user is still holding the item. The user then pulls the item back through the observation zone 703c) until it again ends up outside the reverse vending machine 703d). The tracking and triggering process may conclude that this is not a triggering event based on several observations. One is that the item does not move out of the observation zone with the speed it would move if it was falling freely off the ramp. A second observation might be that the user's hand is continuously present and never lets go of the item. A third observation may be that the next thing that happens after the item has passed through the observation zone is that a similar item (similar because object recognition has not yet been performed so exact classification of the item is not known) moves through the observation zone in the wrong direction.

The final example 704 is one where a user reaches into the reverse vending machine with an empty hand and grabs an item that has already been returned 704a). The user then pulls this item into the observation zone 704b) and out of the reverse vending machine 704c) until it ends up on the outside of machine. In this case it may be observed that no item has passed through the observation zone in the correct direction and no event involving only an object moving in the wrong direction should be a trigger. Also, the user's hand is present in all image frames. Thus, a triggering event is one where it is determined that an item has properly passed through the observation zone subject to at least the conditions that the item has entered the observation zone at the end closest to the opening (201), the item has subsequently left the observation zone from the end opposite to the opening (201), and the item has been tracked continuously through the observation zone. Some embodiments add additional conditions such as exclusion of items that are clearly not consistent with qualifying items, and exclusion of events where some suspicious additional object is detected in the images. The examples shown in FIG. 7 describe detection of a hand as indicative of potential fraud (i.e., something that precludes triggering), but the triggering process may also be configured to detect other types of objects that a user may use to try to manipulate the machine, such as a string, a wire, or a tool of some sort.

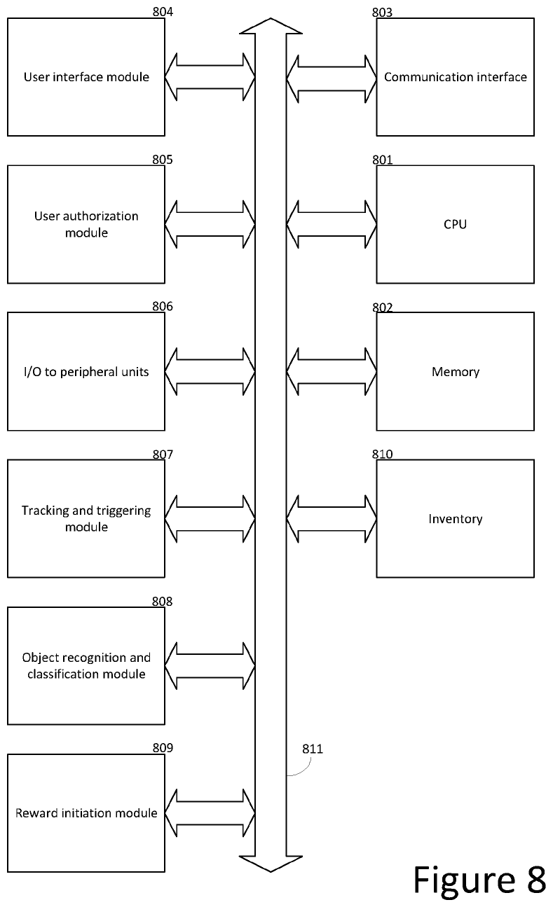

FIG. 8 is a block diagram illustrating an embodiment of the controller 305. This embodiment is based on a general-purpose computer with a CPU 801, memory 802 and a number of modules 803-809 which may be implemented in a combination of hardware and software. The CPU 801 executes instructions that are stored in memory 802 and that may constitute parts of the various modules. However, there may be processing capabilities (i.e., additional processing hardware) in some of the modules, and the controller 305 is, of course, not limited to embodiments with one CPU. The CPU and the modules communicate over a common communication bus 811, but several communication buses may be present in some embodiments. It should be understood that the modules shown in this illustration constitute parts of the reverse vending machine that are configured to communicate with other parts described above, or to perform different aspects of the processing that has been described. To the extent that an embodiment does not include such an aspect, the corresponding module may not be present. As such, the illustration in FIG. 8 may be thought of as a superposition of embodiments with fewer modules, and FIG. 8 is intended to be an illustration of any embodiment with only a subset of the modules shown. Furthermore, the modules represent implemented functionality that perform or relate to one aspect, but the actual implementation in hardware and software does not have to include modules that are distinct. Instead, different modules may share some hardware or software with other modules, while some hardware or software that is utilized by only one module may be distributed over several parts of the system as a whole.

The controller includes a communication interface 803 which is capable of communicating over a computer or telecommunications network with remote computers collectively referred to as the cloud 114. Cloud computing is a well-known concept in the art and will not be described in detail herein. The cloud computing capabilities may be executed on one or more servers or other computers connected to a computer network such as the Internet, and some of the processing described herein as being performed by the controller 305 may in some embodiments be delegated to the cloud 114.

A user interface module is connected to the user interface 203 and configured to receive user input including data required for user identification and authorization, and in some embodiments, item recognition based on e.g., QR codes or RFID. The type of data received by the user interface module 804 depends on the type of user input a particular embodiment of the invention implements, such as camera, text input from a keyboard or a touchscreen, fingerprint reader, RFID or NFC reader, and more. The user interface module 804 may also be capable of delivering output for example to a display part of the user interface 203 in the form of text or symbols, and possibly also lights and audible signals.

A user authorization module 805 receives data from the user interface module 804 to process and determines if access should be given. The capabilities implemented in this module depend on how user identification and authorization is implemented, and may vary among a range of possibilities that are known in the art.

If the user authorization module concludes that access should be given, an input/output unit 806 connected to peripheral units deactivates a mechanism that otherwise locks the machine (or activates an actuator or motor that opens the door 202). The I/O to peripheral units 806 may also be connected to other units such as the image sensor 302, the user interface 203, the light source 304 and any other device or unit being controlled by or delivering data to the controller 305. As already mentioned, some devices may be activated by other mechanisms than the controller 305, for example by a switch connected to the door 202. The I/O to peripheral unit or units 806 is thus the connection between the internal modules in the controller 305 and the external devices of the reverse vending machine 200.

A tracking and triggering module 807 receives image frames from the image sensor 302 and tracks objects that move through the observation zone, as described above. The tracking and triggering module 807 may trigger on any object that is present in image frames in a manner that shows movement through the observation zone. In some embodiments the tracking and triggering module 807 may be configured to require certain values or features associated with parameters such as area, volume, shape, color and more. These parameters may in some embodiments be accessible to be configured by an operator. The tracking and triggering module 807 may also be configured to reject triggers if certain objects are detected in addition to the object that is a representation of the returned item, for example a hand, or something that may be attached to the item such as a wire. Rejection may also be based on movement, for example movement in the wrong direction or movement that is inconsistent with an item that is sliding down the ramp 301 and then falling.

The tracking and triggering module 807 may implement a computer vision algorithm which recognizes objects in the observation zone and is able to track an object from frame to frame. Rejection of triggering events may be based on configurable parameters in this algorithm.

The tracking and triggering module 807 may further be configured to select one or more images from the sequence of image frames representing the triggering event. This selection may include only one representative image, a number of images showing the item from different perspectives, or all images that constituted the triggering event. The selection may be based on a predetermined rule and may also be dynamic based on the quality of the images. The images selected by the tracking and triggering module 807 will be forwarded to an object recognition and classification module 808.

From this description it will be realized that tracking and triggering does not depend on aspects of the observation zone, such as its size, whether there is a ramp 301 or not, and if there is, whether it is flat or curved, moving or fixed, etc. Tracking and triggering does also not depend on whether one or several objects are moving through the observation area at the same time, whether objects are in contact with a surface or falling freely. That being said, it is consistent with the principles of the invention to do include consideration of such aspects in the tracking and triggering process, but it is not essential. In embodiments with a ramp, tilting may influence which images the tracking and triggering module 807 selects for forwarding to object recognition and classification module 808.

The object recognition and classification module 808 receives images selected by the tracking and triggering module 807 and uses an object recognition algorithm to identify a returned item. The object recognition algorithm may be based on computer vision including one or more of image processing, image analysis and neural networks, as well as other artificial intelligence methodologies. If a neural network is used it may, for example, be a convolutional neural network (CNN)that has been trained to recognize the items that the reverse vending machine 200 is intended to receive.

After an item has been successfully recognized and classified the relevant information is provided to a reward initiation module 809. This module may be configured to communicate to the cloud 114 what the user has returned and who the user is. In the cloud this may be translated to a monetary value or some other form of credit and added to a record associated with the user, a user account. In some embodiments the reward initiation module 809 is configured to request information regarding the reward value of the returned items from the cloud 114 or from a lookup table stored in local memory 802 and to calculate and store the resulting reward locally 802 or in the cloud 114. The reward values of various items are not necessarily available from a single source in the cloud 114, and the user accounts may be kept separately from the sources of reward value, or everything may be performed in the same place. The module is referred to as a reward initiation module because it initiates the reward process, but whether it also determines the size or type of reward and provides the reward may vary in different embodiments. In some embodiments the reward initiation module 809 only initiates the reward process for example by transmitting the information required for rewarding to a cloud-based service (e.g., user identification and an identification of a returned item). In other embodiments the reward initiation module 809 also determines what the reward should be, for example by looking this up in a table or database either stored locally in memory 802 or available from a cloud-based service 114. Finally, in some embodiments the reward initiation module 809 also credits a user with the reward by performing a transaction towards an account, a user database or some other record of users and rewards.

Finally, the controller 305 may include an inventory module 810. In some embodiments this module may simply be in communication with a sensor that detects how full the reverse vending machine 200 is and issues an alarm if emptying is required. Such a sensor may, for example, be a LIDAR sensor. In other embodiments the inventory module 810 registers every returned and classified item and keeps track of what the reverse vending machine 200 contains. This information may be useful in order to determine if sorting and distribution to more than one recipient is required.

The present invention facilitates efficient return of products and materials in a circular economy. Since a reverse vending machine 200 according to the invention does not rely on a separate trigger sensor which in turn triggers a video camera, the design of the physical design of the machine can be general purpose, while the training and/or parametrization of the tracking/triggering as well as the object detection and classification processes can be adapted to specific needs. This means that any machine can be programmed to receive a narrow or a wide range of items, and rewards earned by users can similarly be freely and flexibly adapted to needs. Since the machine recognizes each returned item and can be configured to recognize any type of item that fulfills very general parameters relating to materials and dimensions, a reverse vending machine according to the invention can report to the cloud what its contents are at any time. This can be used not only to determine whether the machine is full and needs to be emptied, but also what kind of items it contains, whether sorting is required, and what the destination or destinations for the contents should be. This, in turn, means that efficient implementation of a circular economy such as the one illustrated in FIG. 1 can be facilitated by reverse vending machines that can be adapted to almost any scenario independent of the nature of the returned items, the cloud processing, logistics associated with retrieving and transporting the returned items, and the reward system. For example, some machines may be configured to only accept one type of item, or only items that shall be returned to one recipient, while other machines may be configured to receive a wide range of objects intended to be returned to different recipients, even different categories of recipients including, for example, reuse, repair, and recycle. Earlier reverse vending machines do not provide this flexibility and are mainly only configured to operate within a predetermined ecosystem, particularly those established for return and reuse of drinking containers.

Reverse vending machines according to the invention may be configured in various dimensions depending on where they are intended to be placed, how large items the are intended to receive and the volume of returned items they are intended to hold before they have to be emptied. A model much like the one illustrated in FIG. 2 may have a footprint of approximately 500 mm×500 mm and a height of about 1500 mm. A larger model may increase the footprint to 500 mm×1000 mm, or even to 1000 mm×1000 mm. However, these are examples, and they are not intended to be limiting. Larger models may be contemplated, for example with a width of more than 1000 mm and a height of about 2000 mm and with an opening 201 of maybe as much as 1000 mm×1000 mm. For larger or heavier items, the ramp 301 may be supplemented by a conveyor configured to transport items up to the highest point of the ramp. Such a conveyor could also be arranged after the highest point of the ramp in order to transport items out of the observation zone. Smaller models may also be useful, for example for return of syringes or other medical waste. The invention may also be implemented without any associated compartment for holding the returned items. Instead, the observation zone and associated features may be part of an opening in a wall through which items are passed. On the other side of the wall there may be a bin or container or some other receptacle, or a conveyor configured to transport the items towards storage, sorting, or other processing.

Various further modifications are within the scope of the invention. For example, while the invention in the embodiments described rely on authentication in order to only provide access to authorized and known users in order to prevent return of unqualifying items including waste, or removal of returned products from the machine. However, some embodiments of reverse vending machines according to the invention may always allow access to the interior and allow return of qualifying as well as non-qualifying items. Such an embodiment would operate as a reverse vending machine for qualifying items and simply as a trash can for non-qualifying items. Sorting of the returned items would then be performed downstream from the machine, after the contents have been collected. It is even consistent with the principles of the invention to connect the reverse vending machine to a sorting unit which immediately sorts returned items based on the recognition done by the object recognition and classification process. No such sorting unit is described herein, and it would not be part of the invention as such.

Another possible modification is to arrange the door 202 at the other side of the observation zone, or alternatively to add an additional door after the observation zone. Opening of this door may depend on successful identification of the returned item as a qualifying item. In embodiments with this configuration there may be an additional step after step 607 which opens or enables opening of this door contingent on successful classification or prompts the user to remove the item if it cannot be classified. In embodiments with this configuration the reverse vending machine 200 may be configured to give access provided that the item is identified, whether or not the user is authorized, and to reward the user dependent on identification/authorization of the user (or use different methods to reward users depending on whether the user is authorized or not). In embodiments where the door 202, or an additional door, is provided after the observation zone the reverse vending machine may also include a second additional door, or a second position for the door positioned after the observation zone. If the item is rejected, based either on failed triggering or the item not being recognized and classified as an item associated with a reward, this door may be opened, or may be moved to a second position such that the item is returned to the user, or otherwise transported out of the observation zone apart such that it does not end up together with qualifying items.

In the disclosure presented herein, the various functions performed external to the reverse vending machine 200 and not part of the machine as such, have been referred to as cloud-based services 114. It is believed unnecessary to describe these in detail in as much as they do not constitute part of the invention described and claimed herein. Those with skill in the art will realize that a cloud-based service may be implemented on one or more servers or other computing devices connected to a communication network such as the Internet. Different parts of the service or services may be operated on different devices and may even be under the control of different entities. For example, one cloud-based service may implement functionality relating to the state of the reverse vending machine in terms of need for emptying, servicing, and repair. Another cloud-based service could implement functionality relating registration of qualifying items, determination of reward, registration of authorized users and so on. A third cloud-based service could handle the actual transactions, for example by depositing funds to a user's bank account. These cloud-based services could all be provided by respective servers.

1. A reverse vending machine, comprising:
a user interface configured to receive user input representing an identification of a user;
an opening through which items can be inserted into the machine;
at least one image sensor configured to capture images of items as they are inserted into and moves through an observation zone in the reverse vending machine;
a tracking and triggering module configured to receive images from the image sensor and analyze image sequences to determine whether an item has been introduced into the reverse vending machine and has properly passed through the observation zone, and if it is determined that an item has properly passed through the observation zone, selecting at least one image from a sequence of images of that item in the observation zone;
an object recognition module configured to determine if an object in an image selected by the tracking and triggering module can be recognized as a representation of an item associated with a reward; and
a reward initiation module configured to, upon determination by the object recognition module that an item associated with a reward is represented in an image selected by the tracking and triggering module, performing at least one of storing or transmitting information that provides or can be used to provide the reward associated with the recognized item to a user identified by the user input.

2. A reverse vending machine according to claim 1, further comprising
a ramp provided adjacent to the opening and comprising at least one of a flat surface with an edge and a curved surface such that when an item is introduced into the interior of the machine through the opening it will tilt when passing over the top or off the edge of the ramp allowing the image sensor to observe the item from different sides.

3. A reverse vending machine according to claim 2, where the ramp is a flat surface comprising one of: a) a single flat surface with an edge facing away from the opening, and b) two differently inclined planes, where the first plane is adjacent to the opening and sloping upwards and the second is following the first plane and sloping downwards, and the edge is defined by the meeting of the two planes.

4. A reverse vending machine according to claim 1, where the at least one image sensor is a LIDAR.

5. A reverse vending machine according to claim 1, where the at least one image sensor is a camera or a multispectral camera, and the reverse vending machine further comprises a light source configured to emit soft light with a spectrum consistent with the spectral sensitivity of the camera.

6. A reverse vending machine according to claim 1, further comprising at least one mirror provided in the observation zone and with a position and orientation which allows the at least one image sensor to simultaneously view an item in the observation zone directly from a first angle and in the at least one mirror from a second angle.

7. A reverse vending machine according to claim 1, further comprising a door covering the opening and provided with a locking mechanism, and an authorization module, and wherein the authorization module is configured to deactivate the locking mechanism to provide access to the interior of the reverse vending machine only upon successful authorization of a user identified by user input received by the user interface.

8. A reverse vending machine according to claim 1, further comprising a door provided at the end of the observation zone and provided with an opening mechanism, and where the object recognition module is further configured to activate the opening mechanism only upon positive determination that an object in an image selected by the tracking and triggering module can be recognized as a representation of an item associated with a reward.

9. A reverse vending machine according to claim 1, wherein the tracking and triggering module is configured to use a computer vision algorithm to track an object in a sequence of images and to determine that an item has properly passed through the observation zone only if tracking the object in the sequence of images indicates that:
a) the item has entered the observation zone at the end closest to the opening,
b) the item has subsequently left the observation zone from the end opposite to the opening, and
c) the item has been tracked continuously through the observation zone.

10. A reverse vending machine according to claim 1, wherein the object recognition module is configured to use a computer vision algorithm selected from the group consisting of: image processing, image analysis and neural networks.

11. A reverse vending machine according to claim 1, wherein the reward initiation module is configured to perform at least one of:
a) transmitting to a cloud-based service, an identification of a user and an identification of a returned item;
b) transmitting to a cloud-based service, an identification of a user and a representation of a reward value; and
c) adding a reward value to a locally stored record associated with the identified user.

12. A reverse vending machine according to claim 1, further comprising an inventory module configured to maintain a record of items that have been determined by the tracking and triggering module to have been properly returned and have been recognized by the object recognition module as an item associated with a reward.

13. A method of receiving an item in a reverse vending machine and providing a reward, the method comprising:
receiving user input representing an identification of a user;
providing access to the interior of the reverse vending machine;
using an image sensor to observe an item that is moved through an observation zone;
using a tracking and triggering module to analyze a sequence of images from the image sensor to determine whether an item has properly passed through the observation zone;
if it is determined that an item has passed through the observation zone, selecting at least one image from the sequence of images;
using an object recognition module to determine if an object in the at least one selected image is a representation of an item associated with a reward; and
if an object in the at least one image is recognized as a representation of an item associated with a reward, storing or transmitting information that provides or can be used to provide the reward associated with the recognized item to a user identified by the user input.

14. A method according to claim 13, wherein the observation zone includes a ramp with at least one of a flat surface with an edge and a curved surface such that when an item is introduced into the interior of the machine through the opening it will tilt while moving across the surface of the ramp allowing the image sensor to observe the item from different sides.

15. A method according to claim 14, where the ramp is a flat surface comprising one of: a) a single flat surface with an edge facing away from the opening, and b) two differently inclined planes, where the first plane is adjacent to the opening and sloping upwards and the second is following the first plane and sloping downwards, and the edge is defined by the meeting of the two planes.

16. A method according to claim 13, wherein the observation zone further includes at least one mirror provided in the observation zone and the method further comprises simultaneously viewing an item in the observation zone directly from a first angle and in the at least one mirror from a second angle.

17. A method according to claim 13, further comprising evaluating the information representing an identification of a user to determine if the identified user is authorized to use the reverse vending machine and only providing access to the interior of the reverse vending machine if it is determined that the user is authorized.

18. A method according to claim 13, wherein the use of a tracking and triggering module to determine if an item has properly passed through the observation zone includes using a computer vision algorithm to track an object in a sequence of images and to determine that an item has properly passed through the observation zone only if tracking the object in the sequence of images indicates that:
a) the item has entered the observation zone at the end closest to the opening,
b) the item has subsequently left the observation zone from the end opposite to the opening, and
c) the item has been tracked continuously through the observation zone.

19. A method according to claim 13, wherein the use of an object recognition module to determine if an object in the at least one selected image is a representation of an item associated with a reward includes using a computer vision algorithm selected from the group consisting of: image processing, image analysis and neural networks.

20. A method according to claim 13, wherein the storing or transmitting information that provides or can be used to provide the reward associated with the recognized item to a user identified by the user input used includes at least one of:
a) transmitting to a cloud-based service, an identification of a user and an identification of a returned item;
b) transmitting to a cloud-based service, an identification of a user and a representation of a reward value; and
c) adding a reward value to a locally stored record associated with the identified user.

21. A method according to claim 13, further comprising maintaining a record of items that have been determined through use of the tracking and triggering module to have been properly returned and have been recognized through use of the object recognition module as an item associated with a reward.
